(19) United States
(12) Patent Application Publication
(10) Pub. No.: US 2019/0391713 A1
(43) Pub. Date: Dec. 26, 2019

(54) Community Resource Allocation

(71) Applicant: Mambo, LLC, Dallas, TX (US)

(72) Inventor: Deanna Charles, Dallas, TX (US)

(73) Assignee: Mambo, LLC, Dallas, TX (US)

(21) Appl. No.: 16/017,624

(22) Filed: Jun. 25, 2018

(51) Int. Cl. G06F 3/0483; G06F 3/0482; G06Q 50/00; G06Q 10/10

(52) U.S. Cl. CPC G06F 3/0483; G06Q 10/1095; G06Q 50/01; G06F 3/0482

(57) ABSTRACT

A community activity and event coordination platform is provided that is based on a centrally managed platform that can be used in any community (school, university, retirement village, etc.) to connect community members through activities and events. The event coordination platform may be hosted on a server that is configured to send and receive information about one or more events available to the community. Furthermore, a user may belong to more than one community managed on the event coordination platform and the user may be able to move between communities using a single set of login credentials. Additionally, the event coordination platform may include an administrative module that provides an administrative interface for administrative personnel to monitor events posted to the event coordination platform and selectively control the administrative module to display a schedule of events viewable on the home pages of each user.

### TECHNICAL FIELD

The present disclosure is related generally to mobile communication devices, and, more particularly, to a system and method for modifying a communication mode of a mobile communication device based on user speech characteristics.

### BACKGROUND

Although the internet and the explosion of smaller networks and community sites have led to increased opportunities for users to share ideas and for small groups of users to coordinate activities, there is still no easy way for members of a community at large to seamlessly coordinate community activities and events. For example, while one person may text another person that they know and set up a tennis date, there is no convenient mechanism to allow users who are not yet known to one another to accomplish such a task. Moreover, as the group size needed for an activity rises, the complexity of scheduling such an activity in an ad hoc manner rises as well.

While the present disclosure is directed to a system that can eliminate certain shortcomings noted in or apparent from the above, it will be appreciated that such a benefit is neither a limitation on the scope of the disclosed principles nor of the attached claims, except to the extent expressly noted in the claims. Additionally, the discussion in this Background section is reflective of the inventors' own observations, considerations, and thoughts, and is not intended to catalog or summarize any item of prior art. As such, the inventors expressly disclaim this section as admitted or assumed prior art. Moreover, the identification or implication herein of a desirable course of action reflects the inventors' own observations and ideas, and therefore cannot be assumed to indicate an art-recognized desirability.

### SUMMARY

In keeping with an embodiment of the disclosed principles, a system is provided for creating a customized community experience via a network and multiple nodes. An administrative platform initially uploads information regarding resources and activities from one or more authorized users. The information regarding resources and activities is then made available to participants, e.g., students, retirees or other community members, these participants are able to select among customized categories to identify resources and activities in which they are interested. Categories may be, for example, “therapy” for retirees or “career” for students. At this point, the user's homepage view shows what resources and activities are trending overall within the community as well as in their particular categories of interests (e.g., followed under “my interests”).

With respect to accessing information on the user's home page, a user may belong to multiple communities or organizations that utilize the system to make information regarding resources and activities available to community members. Accordingly, the user can access multiple home pages related to each different community. In an embodiment, this entails using an application on the system website that generates a community list of all the communities the user belongs to.

In an embodiment, a system for informing a group of individuals, each individual having access to an electronic device for accessing data over a network is disclosed. The system may include a server hosting a scheduling application and administrative interface configured to display a community organizer site accessible to the group of individuals. The system may further include a user interface accessed by each individual of the group of individuals for viewing the community organizer site over the network by one or more individual of the group of individuals, and allow each individual of the group of individuals to long into a personal home page of the community organizer site and view a plurality of events communicated on the community organizer site.

In a further embodiment, a method of accessing a system for informing a group of individuals, each individual of the group of individuals capable of sending and receiving data related to a plurality of events over a network, is disclosed. The method may include connecting an electronic computing device to the network and accessing a user interface of the system. Furthermore, the method may include logging in to a first community organizer site through the user interface and each individual of the group of individuals being directed to a first personal home page of the first community organizer site. The method may further include navigating the first personal home page to view a subset of the plurality of events previously identified by each individual of the group of individuals for display on the first personal home page. Moreover, the method may include accessing a second community organizer site and being directed to a second personal home page from the first personal home page and navigating the second personal home page to view a subset of the plurality of events previously identified by each individual of the group of individuals for display on the second personal home page.

In a further embodiment a device for informing a group of individuals about an event, each individual having access to an electronic computing device that is communicably coupled the device is disclosed. The device may include a storage module and at least one processing unit coupled to the storage module. A scheduling application and administrative interface may be executed by the at least one processing unit. The scheduling application and administrative interface may be configured to display a user interface that provides the group of users access to a community organizer site. The scheduling application and administrative interface may prompt each individual of the group of individuals to log into the user interface and direct each individual of the group of individuals to a personal home screen of the community organizer site. Furthermore, the scheduling application and administrative interface may generate a community list including a plurality of community organizer sites that each individual of the group of individuals belongs to. The scheduling application and administrative interface may further allow each individual of the group of individuals to use a common set of login credentials to access the plurality of community organizer sites.

Other features and aspects of embodiments of the disclosed principles will be appreciated from the detailed disclosure taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic view of an electronic computing device environment within which embodiments of the disclosed principles may be implemented;

FIG. 2 is a flowchart of a process in accordance with an embodiment of the disclosed principles;

FIG. 3 is a screenshot in accordance with an embodiment of the disclosed principles;

FIG. 4 is a screenshot in accordance with an embodiment of the disclosed principles;

FIG. 5A is a screenshot in accordance with an embodiment of the disclosed principles;

FIG. 5B is a screenshot in accordance with an embodiment of the disclosed principles;

FIG. 5C is a screenshot in accordance with an embodiment of the disclosed principles;

FIG. 5D is a screenshot in accordance with an embodiment of the disclosed principles;

FIG. 6 is a screenshot in accordance with an embodiment of the disclosed principles;

FIG. 7 is a screenshot in accordance with an embodiment of the disclosed principles;

FIG. 8 is a screenshot in accordance with an embodiment of the disclosed principles;

FIG. 9 is a screenshot in accordance with an embodiment of the disclosed principles;

FIG. 10 is a screenshot in accordance with an embodiment of the disclosed principles;

FIG. 11 is a screenshot in accordance with an embodiment of the disclosed principles;

FIG. 12 is a screenshot in accordance with an embodiment of the disclosed principles; and

FIG. 13 is a screenshot in accordance with an embodiment of the disclosed principles.

### DETAILED DESCRIPTION

As noted above, although individuals are able to coordinate activities via interpersonal messaging etc., there is no convenient mechanism to allow users who are not yet known to one another to accomplish such a task. This is not an insurmountable hurdle, but does become nearly so when the number of participants needed for an activity rises to higher levels. Moreover, while certain specific activities may be centrally managed by a dedicated system (e.g., Comic-Con, The Indianapolis 500), there is no open and adaptable platform to allow many different activities of interest to the entire community to be centrally coordinated.

With this in mind, the disclosed principles provide a user interface for a centrally managed system that can be used in any community (e.g., school, university, retirement village, public library, etc.) to connect community members through activities and events. Furthermore, through the user interface, a user may configure the centrally managed system to link a plurality of communities they belong to which utilize the centrally managed system. Additionally, an Administrator of the centrally managed system can utilize an administrative interface to add and/or remove content from the centrally managed system. Furthermore, the Administrator may use the administrative interface to customize how information is displayed and what information is made available to users of the centrally managed system. While the centrally managed system may lend itself to many variations, certain embodiments will be discussed herein to aid the reader in understanding the attached claims.

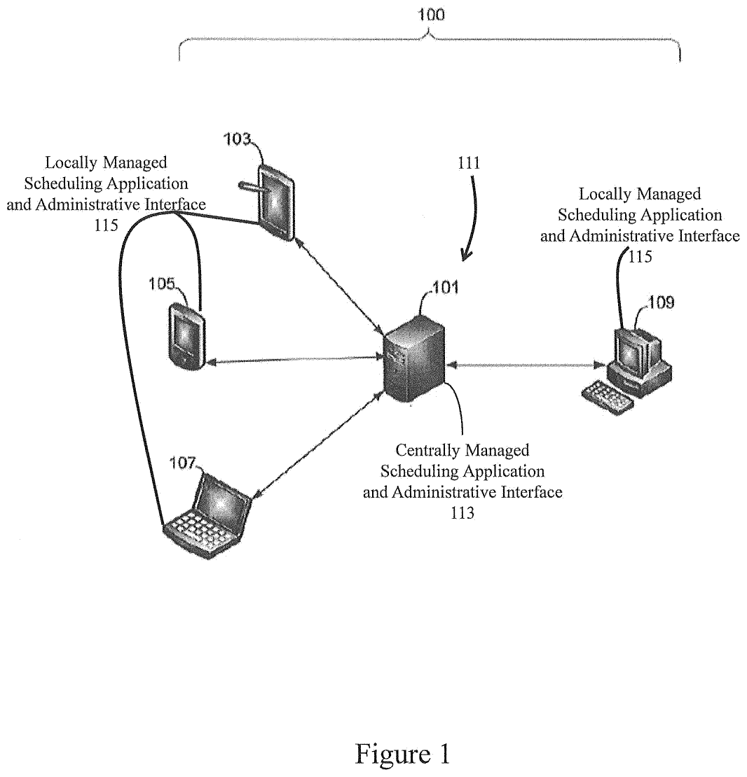

With this overview in mind, and turning now to a more detailed discussion in conjunction with the attached figures, the techniques of the present disclosure are illustrated as being implemented in a suitable computing and network environment. FIG. 1 shows an example of such an environment. In particular, the illustrated computing and network environment 100 includes a server 101 as well as numerous user devices 103, 105, 107 and an administrative device 109. It will be appreciated that a greater or lesser number of user devices may be used and that more than one administrative device may be used, especially if there are numerous administrators in a system.

Each of the user devices 103, 105, 107 and the administrative device 109 may be any portable or stationary computing device capable of communicating electronically, e.g., via a wired or wireless network. Each user device 103, 105, 107 should also have user interface capabilities such that its user may observe information, e.g., on a screen of the device, and may input information, e.g., via a virtual or physical device key board. In an embodiment, the collection of user devices 103, 105, 107 includes one or more of a smartphone device, a laptop device, a desktop PC, and/or a tablet computing device. The administrative device 109 may also be any of these device types.

Each device has a memory module (e.g., non-transient computer-readable medium such as but not limited to RAM, ROM and flash memory), and a processing unit, and executes computer-implemented tasks by retrieving computer-executable instructions from a non-transient computer-readable medium such as one or both of RAM and ROM or other memory structure, and executing the computer-executable instructions on the device processor. Furthermore, the user devices 103, 105, 107 and the administrative device 109 are communicably coupled to the server 101 through a computer data communication network 111 such as but not limited to, a wired communication network, a fiber optic communication network, a wireless communication network, a Wi-Fi data network, a Bluetooth network, a near-field communication network, a radio-frequency communication network, a cellular data network, a satellite data network and the like. As such, the user devices 103, 105, 107 and the administrative device 109 may be in wireless communication with the server 101 such that a user and/or administrator may access a centrally managed scheduled application and administrative interface 113 stored on the server 101.

Accordingly, the centrally managed scheduling application and administrative interface 113 may be stored in a memory module (e.g., non-transient computer-readable medium such as but not limited to RAM, ROM and flash memory) of the server 101. Moreover, the server 101 may include one or more microprocessors which execute algorithms, software and/or other such logic instructions and/or operations that are programmed into the centrally managed scheduling application and administrative interface 113. Thus, for example, the later flowcharts discussed herein will refer to steps, and it will be appreciated that those steps which are computer-implemented on a device are executed in the above manner.

Additionally or alternatively, each of the user devices 103, 105, 107 and the administrative device 109 may have a locally managed scheduling application and administrative interface 113 stored in the device's memory module (e.g., non-transient computer-readable medium such as but not limited to RAM, ROM and flash memory). The processing device of each user device 103, 105, 107 and administrative device 109 execute algorithms, software and/or other such logic instructions and/or operations that are programmed into the locally managed scheduling application and administrative interface 113. Furthermore, the locally managed scheduling application and administrative interface 113 on each user device 103, 105, 107 and administrative device 109 may cooperate or communicate over the computer data communication network 111 with the centrally managed scheduling application and administrative interface 113 stored on the server 101.

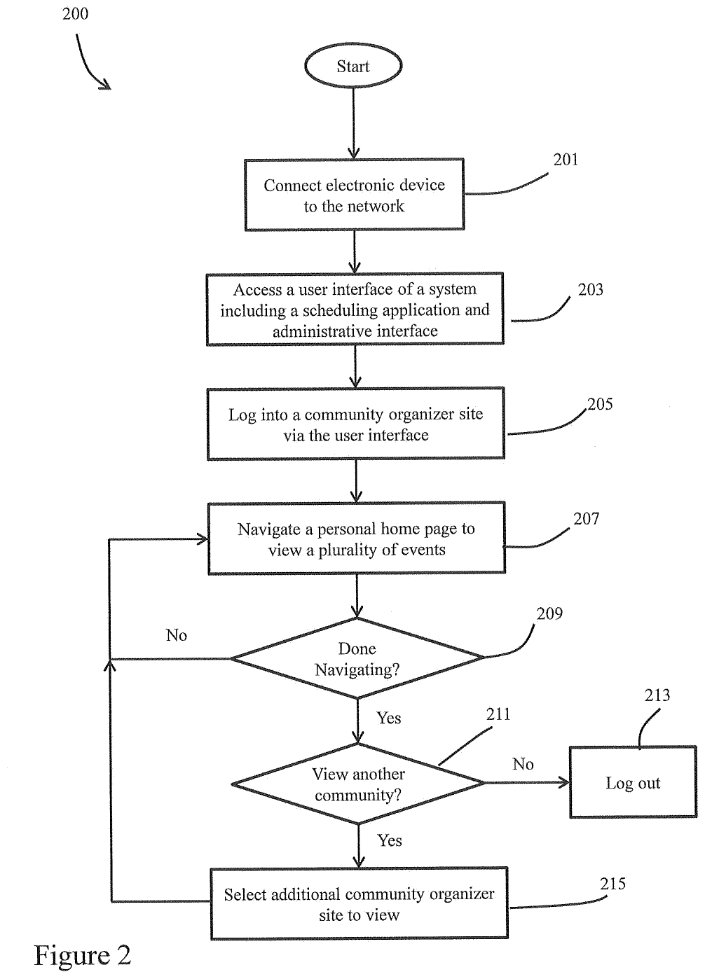

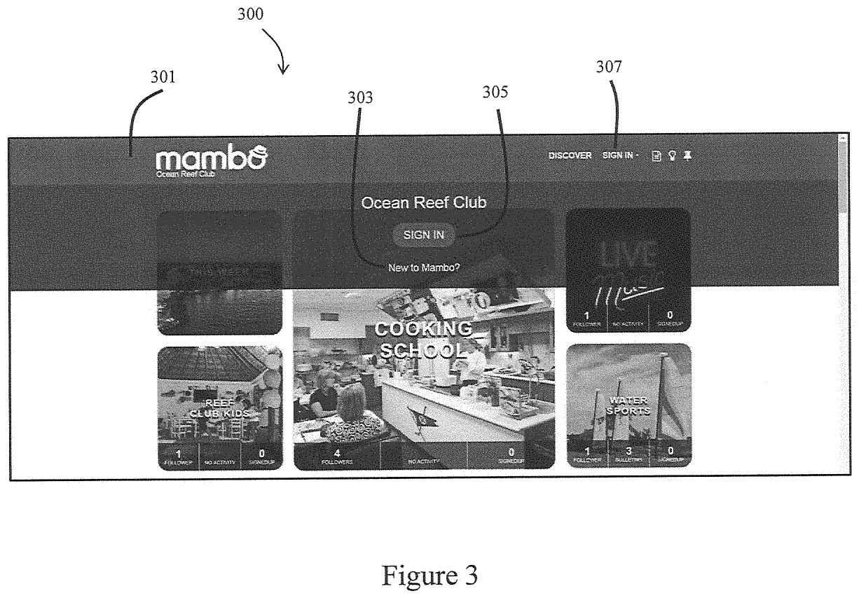

While providing more detailed screenshots corresponding to an implementation of the disclosed principles, several exemplary processes will be outlined in flow chart format to aid the reader. To this end, FIG. 2 shows a flow chart of a process 200 for a user to access the computing and network environment 100 in order to send and receive data and to view one or more community organizer sites 301 of communities and organizations (e.g., school, university, retirement village, public library, etc.) that use the centrally managed scheduling application and administrative interface 113, shown in FIG. 3. Additionally, the user may access the user interface screen 300 to view and/or manage events and activities from one or more communities they are a member of. At stage 201 of the process, the user connects their user device 103, 105, 107 (FIG. 1) to the computing and network environment 100. Once connected, at stage 203, the user accesses the centrally managed scheduling application and administrative interface 113 via the user interface screen 300 which is displayed on their user device 103, 105, 107 (FIG. 1). In one embodiment, the user interface screen 300 directs the user to a community organizer site 301, as shown in FIG. 3. The community organizer site 301 is configured to display and communicate ongoing events and activities at the community (e.g., school, university, retirement village, public library, etc.).

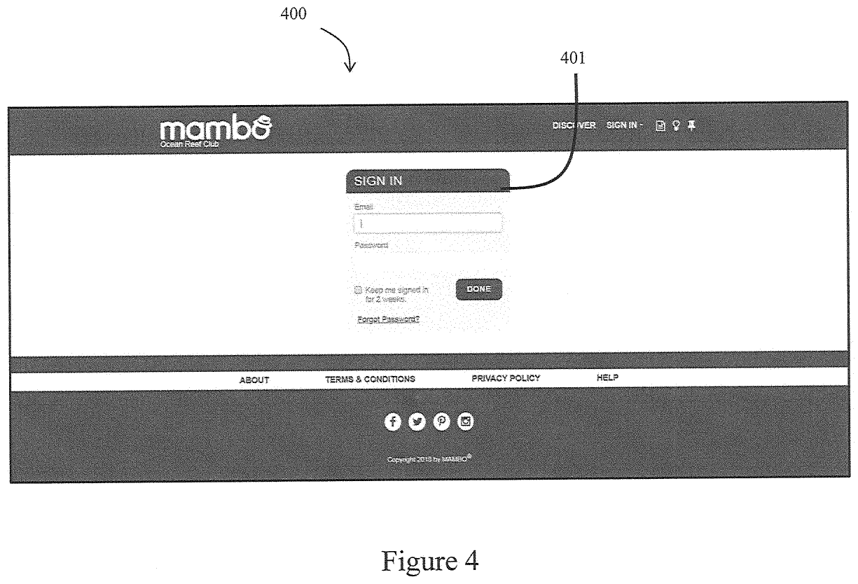

Next at stage 205, the user logs into the community organizer site 301 using the login screen 400 shown in FIG. 4. Assuming the user has already registered, i.e., created an account on the system; the user enters their user name (e.g., email address, or other registered user name), and password into the spaces provided in Sign In box 401. If the user needs to create an account they can do so using the new to mambo link 303 underneath sign in button 305 displayed on the community organizer site 301, as shown in FIG. 3. Alternatively, the user may select the sign in tab 307 located along the top boarder of the user interface screen 300. The sign in tab 307 includes a selection for the user to register for the access and/or membership to the community organizer site 301. The sign-in and/or registration process is similar to traditional processes in that the user provides some basic information as well as a username and password. In one non-limited example, the username is the same as the registered email address associated with the user; however the community organizer site 301 may be configured to accept other user information (e.g., unique user identifier) that can be used as the username.

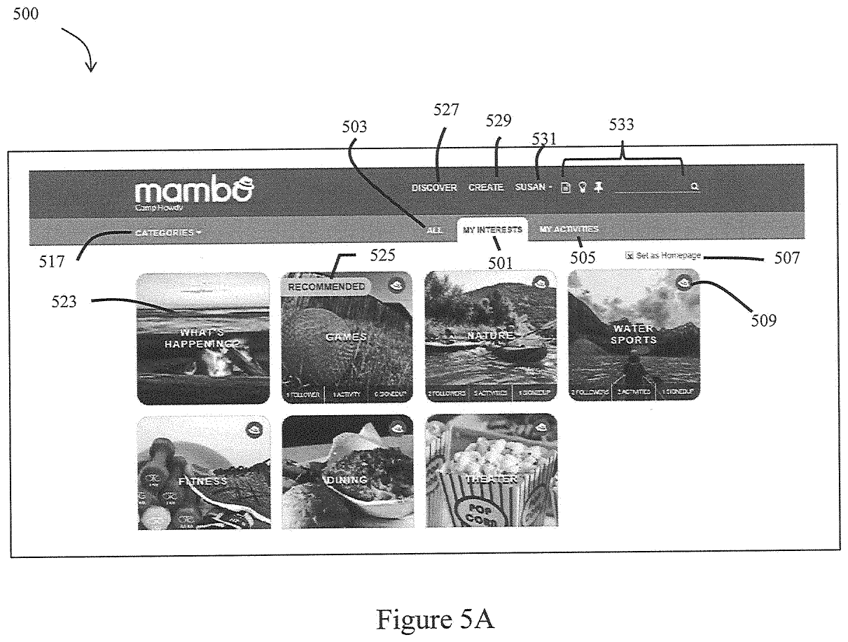

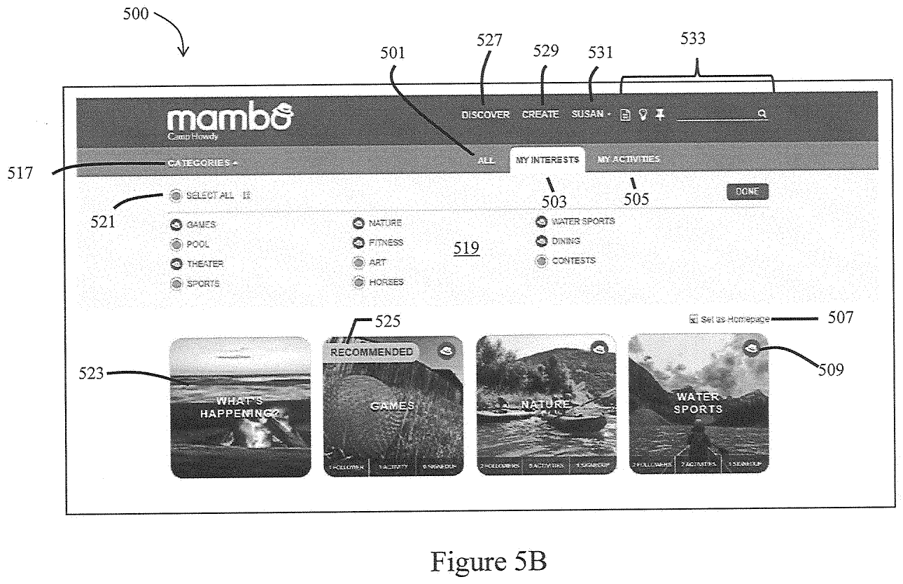

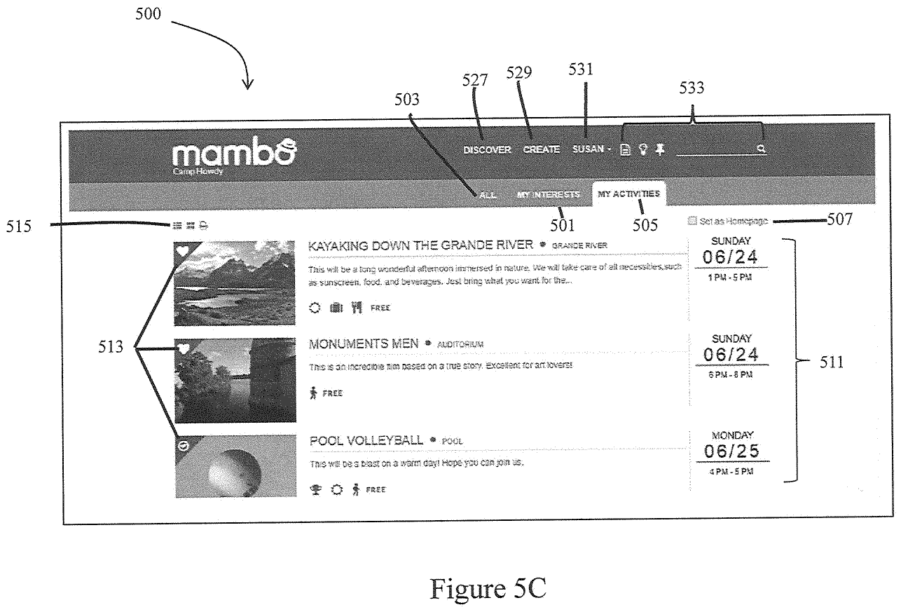

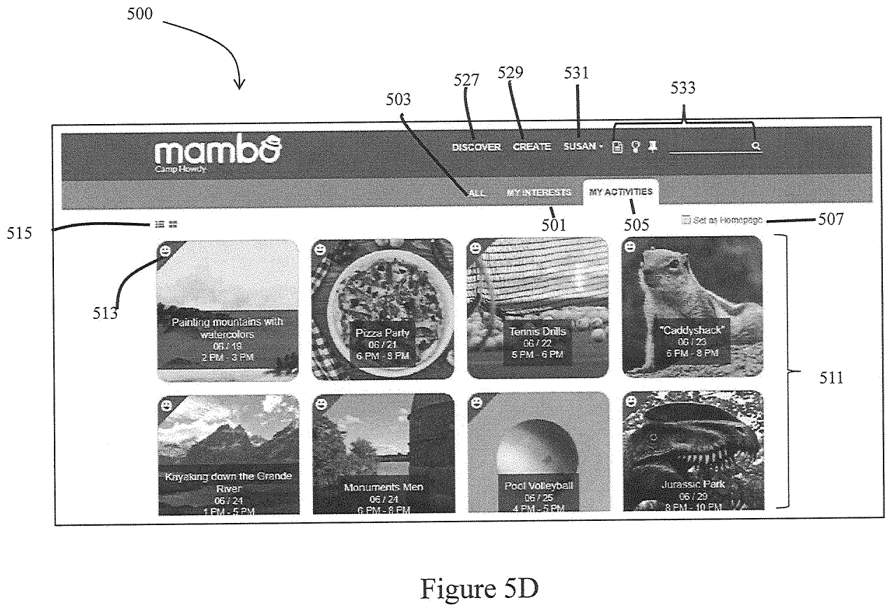

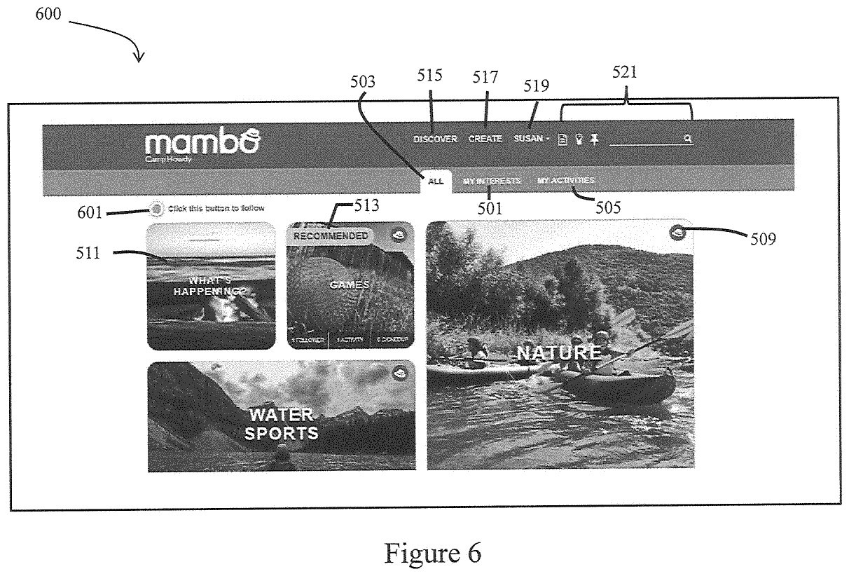

Once the user has logged into the community organizer site 301, the user interface screen 300 directs the user to a home screen such as a personalized home screen 500 of FIGS. 5A-5D or a default home screen 600 of FIG. 6. First, referring to FIGS. 5A-5D, the personalized home screen 500 displays user directed information associated with the specific community organizer site 301 (FIG. 3) the user has logged into. Accordingly, in a next stage 207 of the process 200 illustrated in FIG. 2, the user navigates the personalized home screen 500 to view the content displayed on the site and/or view content they are most interested in. For example, from the personalized home screen 500 of FIGS. 5A-5D, the user can choose from a plurality of tabs to view. As shown, the tabs include a My Interests tab 501, an All tab 503 and a My Activities tab 505; however it will be understood that the Administrator may customize the user interface screen 300 and configure the community organizer site 301 to include and/or exclude information (e.g., tabs), as desired.

In one non-limiting example shown in FIG. 5A, the user can selectably configure the My Interests tab 501 to be designated or otherwise set as their personalized home screen 500. If selected as such, the user is immediately directed to the My Interests tab 501 showing all content contained and/or displayed therein upon login. In an alternative example shown in FIGS. 5C and 5D, the user can selectably designate the My Activities tab 505 as their personalized home screen 500. Accordingly, if the My Activities tab 505 is set as the homepage the user is directed to their My Activities tab 505 upon login.

Such designation of the home page may be made by activating or selecting a set as homepage box 507 located in an upper right hand portion of the personalized home screen 500. The user can designate either the My Interests tab 501 or the My Activities tab 505 to be their personalized home screen 500 by first selecting one of the tabs. The user then selects or otherwise the set as homepage box 507 on the tab they want to set as the homepage. As shown in FIGS. 5A, the set as homepage box 507 is selected and includes an “X” or other such indicator in the set as homepage box 507. If neither the My Interests tab 501 nor the my activities tab 505 is selected as the homepage, then the default home screen 600 (FIG. 6A) may be displayed upon user login. Typically, the default home screen 600 is configured to display the All tab 503 to show all the events and activities scheduled for the specific community; however, the default home screen 600 may be alternatively configured to default to another tab or display other information.

Referring back to the personalized home screen 500 of FIG. 5A, the My Interests tab 501 is configured to display activities and events that were previously marked or selected by the user. Accordingly, an interest indicator 509 (e.g., the hat in circle icon) is visible in the upper right hand corner of each activity displayed under the My Interests tab 501. If the user is no longer interested in the event, or is unable to attend the event, the user may de-select the interest indicator 509 and that activity will be removed from the My Interests tab 501.

Alternatively, on the personalized home screen 500 of FIG. 5C and 5D, the My Activities tab 505 shows a personalized list 511 of what the user is currently scheduled to do. Furthermore, each activity may include a status icon 513 (e.g., smiley face, heart or check mark) to communicate a status to the user. For example, the status icon 513 displaying a smiley face may communicate that the specific activity was created by the user. The status icon 513 displaying a check mark may communicate that the user has signed up for and is currently registered for that specific activity. Moreover, the status icon 513 displaying a heart may communicate that the user has signed up for the event and previously marked the event and/or category as one of their interests.

Moreover, the My Activities tab 505 may include a tile or list display icon 515 which allows a user to change how the content is displayed under their My Activities tab 505. For example, FIG. 5C shows the content arranged under the My Activities tab 505 in a list format and FIG. 5D shows the content arranged under the My Activities tab 505 in a tile format. If the user would like to change the display format they may select the tile or list icon 515 to change the display between the two formats.

As mentioned above, if the user does not make a selection in the homepage box 507 the user will be directed to the default home screen 600 shown in FIG. 6, upon login to the user interface screen 300 (FIG. 3). Similar to the personalized home screen 500, the default home screen 600 includes the My Interests tab 501, the All tab 503 and the My Activities tab 505. The All tab 503 may be configured to lists all the events and activities scheduled at the community.

As further shown in the default home screen 600 of FIG. 6, any events and activities the user has previously designated as being interested in will include the interest indicator 509 (e.g., hat in a circle icon). Furthermore, under the All tab 503 the user can select any newly interested in activities by actively selecting a follow indicator 601. Once selected, the newly interested in activity will be marked with the interest indicator 509 and added to the content listed the user's My Interests tab 501. In other words, the community organizer site 301 updates in real time such that a change in interest and/or registration for an event viewed from the All tab 503 will be immediately updated under the My Interests tab 501 and/or the My Activities tab 505.

Returning back to FIGS. 5A and 5B, an embodiment of the My Interests tab 501 includes a categories button 517 which shows and/or hides a categories drop down menu 519. In the example shown in FIGS. 5A and 5B, the categories button 517 is located in the upper left portion of the screen 500. Activation of the categories button 517 may cause the categories drop down menu 519 to be displayed under a top header portion of the screen 500; however other locations for the categories button 517 and categories drop down menu 519 are possible. As described above, the My Interests tab 501 may generally be configured to display categories and/or events the user has previously expressed interest in. Furthermore, the categories drop down menu 519 may provide a comprehensive list of all categories related to the events and activities scheduled at the community. As such, the user can select specific categories from the categories drop down menu 519 to customize and curate which categories are displayed under their My Interests tab 501.

As further shown in FIG. 5B, selecting the categories button 517 opens or otherwise displays the categories drop down menu 519 that lists all the possible categories available for display under the My Interests tab 501. The user can select and deselect the specific categories they would like displayed under their My Interests tab 501. If the user wants all the categories listed they can select the select all box 521. Alternatively, if the user would like to customize the categories listed they can select the selectable circle next to each category of interest.

In the example shown in FIG. 5B, the circles next to the following categories are checked: Games, Nature, Water Sports, Fitness, Dining and Theater. As a result, only those categories are actively displayed under the My Interests tab 501 and the other categories are hidden and not actively displayed. Note, Fitness, Dining and Theater will be listed under the My Interests tab 501 but are not displayed in the exemplary screen 500 shown in FIG. 5B due to not residing within the screen shot field of view.

Additionally, an embodiment of the personalized home screen 500 and default home screen 600 as shown in FIGS. 5A, 5B and 6, includes a current events box 523 displaying the text “What's Happening?”. As the text suggests, the current events box 523 includes a listing of all the events and activities scheduled at the community for the current week. Furthermore, the Administrator may configure the current events box 523 to display alternative text such as, “This Week,” “Current Events,” “Last Chance to Register,” and other such notifications. Additionally, the Administrator may utilize the centrally managed scheduling application and administrative interface 113 to configure the current events box 523 to be displayed and accessible under the My Interests tab 501, the All tab 503, and the My Activities tab 505. The Administrator for the community can further customize the current events box 523 to display a different message or content. For example, the box may be configured to display the events and activities scheduled for the current day, month or other such time frame. Alternatively, the current events box 523 may be configured to display a weekly or monthly calendar and the user can navigate the calendar to look for events scheduled on specific days or times. Moreover, the Administrator may decide not to display the current events box 523 under the user's my interests tab 501 and/or any of the other tabs (e.g., the all tab 503 and my activities tab 505).

The Administrator of the community organizer site 301 (FIG. 3) may further use the centrally managed application and administrative interface 113 to customize the community organizer site 301, as well as customize how certain information is displayed and communicated. For example, the Administrator can configure the community organizer site to display a recommended banner 525 displayed on certain events and activities. Thus, the community organizer site 301 may be further configured to communicate recommended activities and events to the user when viewing their personalized home screen 500 (FIG. 5A-5D) and/or their default home screen 600 (FIG. 6).

The Administrator may designate which events and activities include the recommended banner 525. In one non-limiting example, the Administrator may use the centrally managed scheduling application and administrative interface 113 to analyze the past events a user has attended and/or marked as being interested in. Thus, the centrally managed scheduling application and administrative interface 113 may be able to compare the past events and future events and identify similar or related events for a particular user. The centrally managed scheduling application and administrative interface 113 may then label the identified similar and/or related events with the recommended banner 525. Additionally or alternatively, the Administrator can identify which events are labeled with the recommended banner 525. This determination can be made globally for all users of the community organizer site 301 (FIG. 3) or may be made for a subset or even individual users of the community organizer site 301 (FIG. 3). Accordingly, the recommended banner 525 may be set by the Administrator to be displayed on events or categories based on a group setting that is included in within the centrally managed scheduling application and administrative interface 113.

In a next stage 209, the user decides whether they are done navigating the personalized home screen 500 and/or the default home screen 600 of the current community organizer site 301 they are logged into. If the user is not done navigating, then the user can remain at stage 207 to continue navigating around home screens 500 and/or 600, or other information contained on the community site. Alternatively, if the user is done navigating the current community organizer site 301, then in a next stage 211 of the process 200 illustrated in FIG. 2, the user decides if they want to view another community site. If the user does not belong to any other community organizer site 301, or does not wish to view another community, then in a next stage 213 the user exits from and/or logs out of the current community organizer site 301. Otherwise, the user can proceed to stage 215 and select another community organizer site 301 to which they belong and view the events and activities associated with that community.

In an embodiment, the personalized home screen 500 and default home screen 600 further include a Discover link 527, a Create link 529 and Site Information link 531. Furthermore, home screens 500 and 600 may include one or more icons 533 such as but not limited to a News Feed, an Idea Submission, a Bulletin Board, a Search bar and the like which may link or otherwise direct the user to additional information related to current activities and events. If at any time the user is interested in looking at a different community they belong to, the user can do so by first selecting the site information link 517.

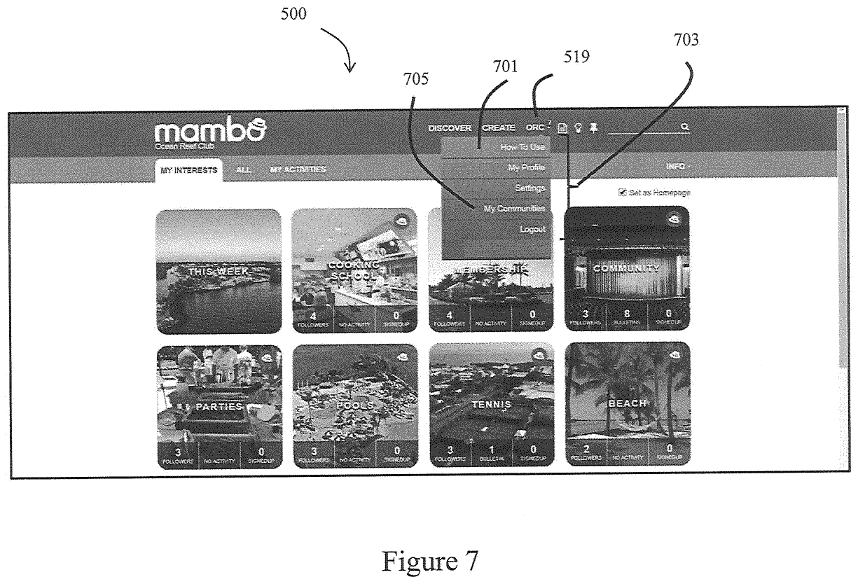

As further illustrated in FIG. 7, when the Site Information link 531 is selected, a drop-down menu 701 is displayed on the personalized home screen 500. The drop-down menu 701 may include a plurality of selectable menu choices 703. In the illustrated example of FIG. 7, the selectable menu choices include How to Use, My Profile, Settings, My Communities and Log out. However, the drop-down menu 701 may be further configured by the Administrator of the community organizer site 301 to display other selectable menu choices 703, as desired. If the user is interested in viewing another community organizer site 301 that they belong to, the user can select the my communities selectable choice 705 from the drop-down menu 701.

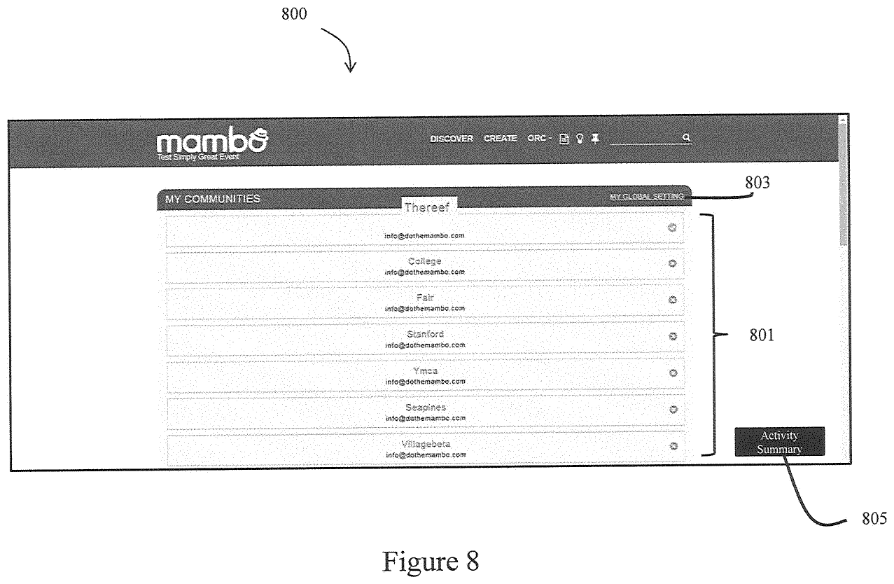

Clicking or otherwise selecting the my communities selectable choice 705 will direct the user to a My Communities screen 800, as shown in FIG. 8. In an embodiment, the centrally managed scheduling application and administrative interface 113 may link all of the communities that a specific user belongs to and displays each community in a community list 801. Thus, an embodiment of the My Communities screen 800 includes a community list 801 with all the communities using the centrally managed scheduling application and administrative interface 113 that a specific user belongs to. The My Communities screen 800 may be configured such that the user can select any community displayed on the community list 801 in order to view the events and activities scheduled for that particular community. As a result, the My Communities screen 800 can help simplify a user's management of the different communities they currently belong to.

Moreover, the inclusion of the my communities selectable choice 705 on the drop-down menu 701 (FIG. 7) and the My Communities screen 800 allows a user to set up a single user name and password to access each personalized home screen 500 and/or default home screen 600 of the communities they currently belong to. The user may choose to link multiple community organizer sites 301 together at the time of signup by using the same user name (e.g., email address) and password during registration for each site. Alternatively, the user may link the multiple community organizer sites 301 together at a later date.

In an embodiment, the My Communities screen 800 may further include an activity summary button 805 which the user can select to obtain a summary of all activities they registered for and/or selected as being interested in across all the community organizer sites 301 they belong to. Accordingly, upon selecting the activity summary button 805, the user may be directed to a Global Summary screen (not shown). In one embodiment, the Global Summary Screen (not shown) may summarize all of the activities a user expressed interest in across all the community organizer sites 301 they belong to. Furthermore, the Global Summary Screen (not shown) may be configured to display activities and events within a specific category across the different communities the user belongs to. For example, the Global Summary Screen (not shown) may list all of the fitness activities scheduled at each community the user belongs to.

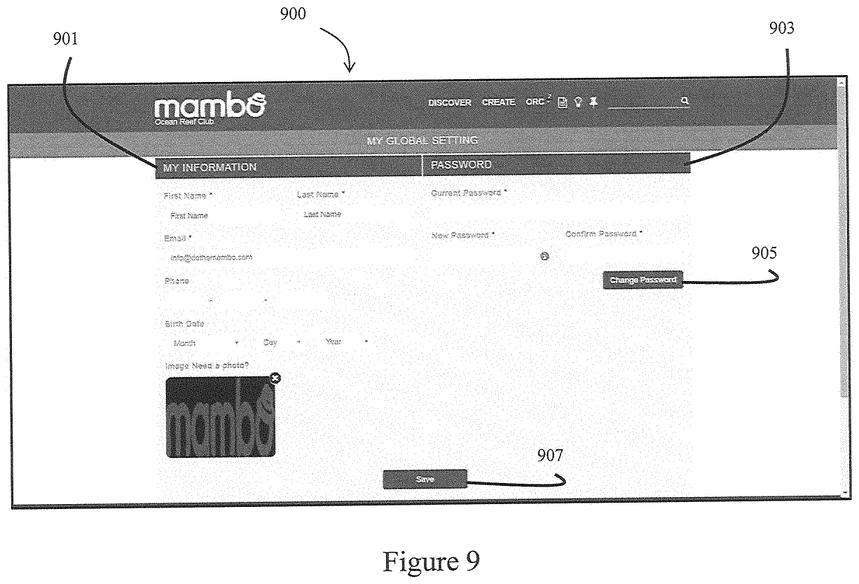

Referring back to FIG. 8, in one non-limiting example, the user can manage their login information through the through a my global settings link 803 listed on the my communities screen 800. Selection of the my global settings link 803 will direct the user to a My Global Settings screen 900, as shown in FIG. 9. The My Global Settings screen 900 includes a My Information tab 901 which further includes input boxes for the user's name (e.g., first name and last name), email address, telephone number and birthdate. Furthermore, the user can upload a photo or image file that can be used to identify the user when logged into the community organizer site 301 operated by the centrally managed scheduling application and administrative interface 113.

Additionally, the My global Settings screen 900 includes a Password tab 903 that further includes an input box for the user's current password as well as input boxes to change the password. The user may initiate a change to their current password by selecting the change password box 905 and then entering in the new password and confirmation in the respective input boxes. Changes made to information entered into the My Information tab 901 and/or Password tab 903 will be saved by selecting the save box 907 located on the My Global Settings screen 900.

The user may access the My Global Settings screen 900 to change to their log in information prompted in the sign in box 401 (FIG. 4) for each community organizer site 301 (FIG. 3) they belong to. Moreover, if the user provided different and/or outdated user information when registering for access to one or more different community organizer sites 301, then the My Global Settings screen 900 may allow the user to update information saved on the My Global Settings screen 900. In other words, if a user belongs to multiple organizations with different community organizer sites 301 that use the centrally managed scheduling application and administrative interface 113, then the user can use the My Global settings screen 900 to update information such that a single user name and password can be used to access all of the user's communities. Furthermore, by using a single user name (e.g., email address) and password, all of the communities which use those log in credentials will be listed on the My Communities screen 800. This may allow the user to transfer back and forth to view information on different community organizer sites 301 without the need to sign out and log back in.

When a user selects another community organizer site 301, process 200 may go back to stage 207 and the user navigates around the personal home screen 500 for the newly selected community organizer site 301. Once the user is done looking at all the community organizer sites 301, the process 200 may then proceed to stage 211 and the user logs out.

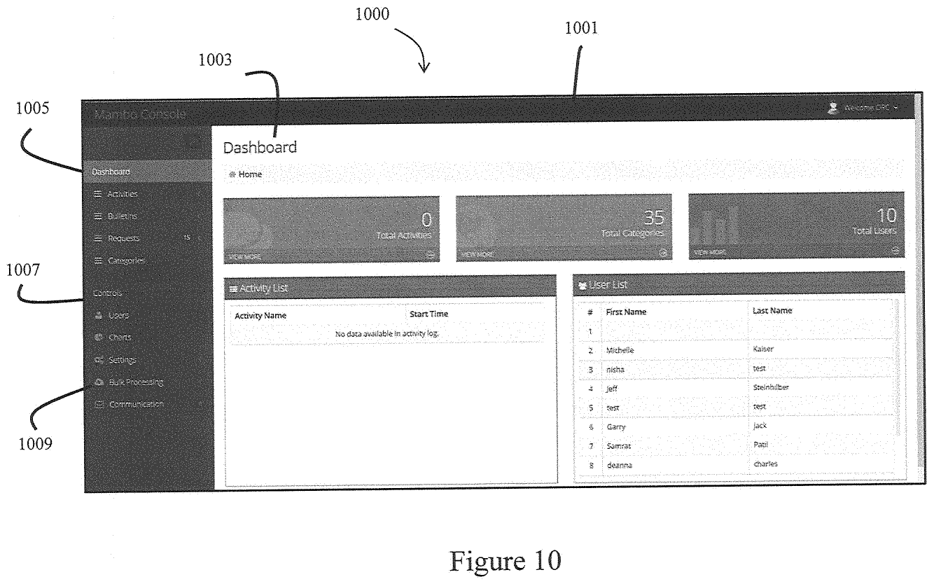

As noted above, one or more Administrators may have access to community organizer sites 301 (FIG. 3) that are maintained, managed or otherwise hosted by the centrally managed scheduling application and administrative interface 113 (FIG. 1). Screenshot 1000 of FIG. 10 shows an exemplary administrative console 1001 that may be accessed and used by the Administrator to set up, edit and maintain a community organizer site 301 maintained by the centrally managed scheduling application and administrative interface 113. The Administrator may access the administrative console 1001, through the administrative device 109 that is communicably coupled to the server 101 (FIG. 1).

Initial access of the administrative console 1001 takes the Administrator to an administrative dashboard 1003 or administrative home page. As shown on screen 1000, the administrative dashboard 1003 displays relevant site information to the Administrator as well as a plurality of tabs and selectable menus. In some cases, the Administrator may first be taken to a log in screen, and prompted to first enter verification credentials such as but not limited to, an Administrator username and password. Once logged in, the Administrator may then be directed to the administrative dashboard 1003 to review data and information displayed therein. Alternatively, the Administrator navigate into one or more of the dashboard tabs 1005 (e.g., Activities, Bulletins, Requests, Categories) and or one or more of the control tabs 1007 (e.g., Users, Charts, Settings, Bulk Processing, Communication) to update, edit and/or otherwise manage the community organizer site 301.

For example, the Administrator may edit or update the community organizer site 301 to communicate a recommendation for certain activities and events to users of the site. As shown in the exemplary personalized home screen 500 of FIG. 5A-5D and default home screen 600 of FIG. 6, one or more of the events and activities listed on the community organizer site 301 may be configured to display the recommended banner 525. The Administrator may selectively choose to display the recommended banner 525 based on a group setting such that events and activities may be recommended to users based on one or more groups (e.g., Equity, Social, Guest and Staff) they belong to. As such, when the user logs onto the community organizer site 301 and views the listed activities and events the user will see which events and activities have also been recommended. In an embodiment, the Administrator can recommend one or more of the activities and events from the dashboard tabs 1005 that are visible on the administrative dashboard 1003.

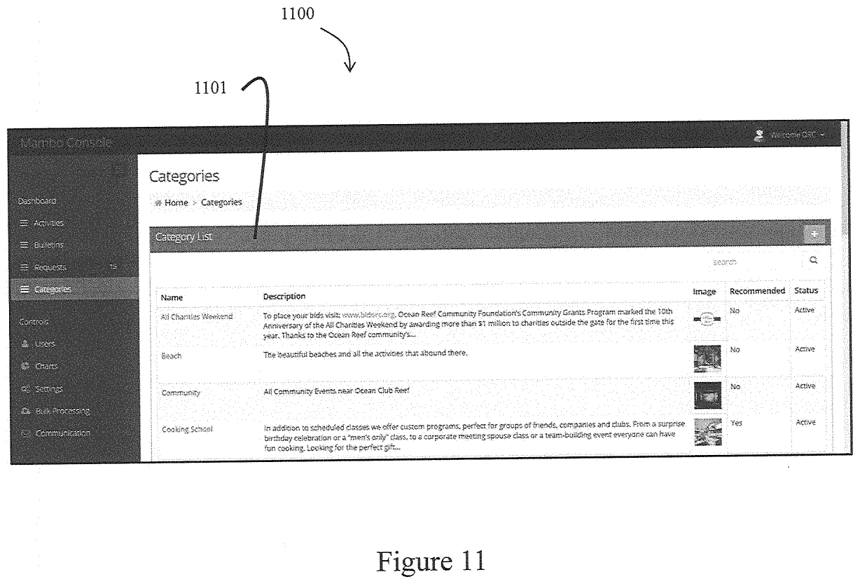

To add a recommendation the Administrator can select the categories tab or menu listed under the dashboard tabs 1005. The Administrator will then be directed to a Categories screen 1100 as shown in FIG. 11. The Categories screen 1100 displays a categories list 1101 that displays events and activities that are listed on the community organizer site 301. Furthermore, the categories list 1101 is organized to display a summary of each activity and event including but not limited to, category name, brief description, thumbnail image, recommended status, current status on site (i.e., active or inactive) and the like.

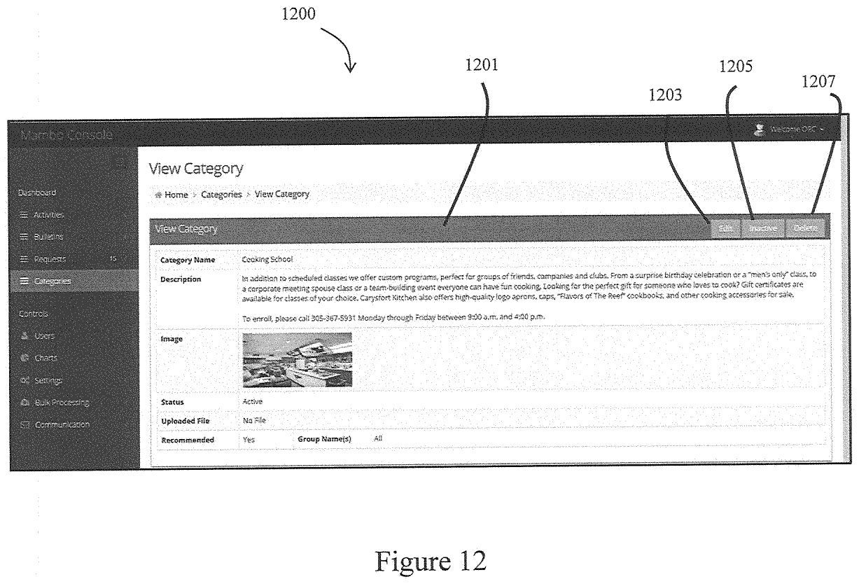

The Administrator then can select or click on the name of the specific category name (i.e., event or activity) they would like to view and edit. As further illustrated in screen 1200 shown in FIG. 12, a view category box 1201 is displayed. The view category box 1201 displays the information related to the category (i.e., event or activity) along with an edit button 1203, a site status button 1205 and a delete button 1207. If the Administrator wants to edit the category the edit button 1205 is selected. Alternatively, if the Administrator wants to change the category status (e.g., from active to inactive or vice versa) the site status button 1205 is selected. Furthermore, if the Administrator wants to delete the category from the community organizer site 301 then the delete button 1207 is selected.

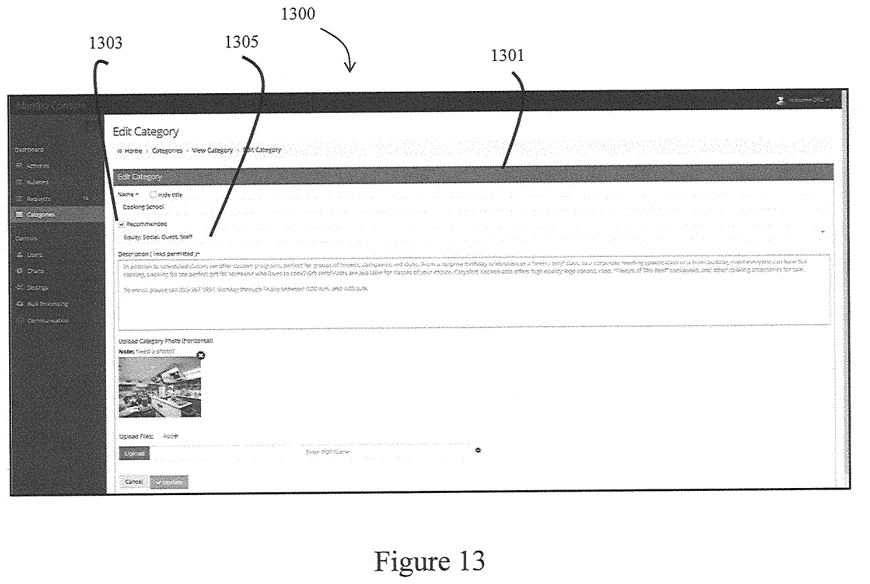

Should the Administrator want to recommend the category shown in the view category box 1201 the edit button 1203 can be selected to direct them to an edit screen 1300 shown in FIG. 13. Edit screen 1300 includes an edit category box 1301 which allows the Administrator to edit the category name, recommend the category, edit the category description, upload a category picture and other such edits. To recommend the category, the Administrator can select a recommended box 1303 to identify the category as being recommended. Additionally, the Administrator can select specific groups the category should be recommended to by selecting specific user groups (e.g., Equity, Social, Guest and Staff) in a recommended to box 1305. Thus, the Administrator can configure the category recommendation to be communicated to the appropriate user groups (e.g., Equity, Social, Guest and Staff).

Conversely, should the administrator want to remove a previously set recommendation the recommended box 1303 can be deselected and the recommendation will be removed from the category. Additionally, as discussed above, the centrally managed scheduling application and administrative interface 113 may be programmed to analyze data from the community organizer site 301 to recommend categories to one or more of the user groups (e.g., Equity, Social, Guest and Staff). The centrally managed scheduling application and administrative interface 113 may select recommendations based on past user activity, event popularity and other such parameters.

Referring back to screen 1000 of FIG. 10, the Administrator accesses the administrative console 1001 to perform other administrative tasks such as adding new events and activities to the community organizer site 301. In an embodiment, the Administrator may use a bulk processing tab 1009 included under the control tabs 1007. The bulk processing tab 1009 is configured to allow the Administrator to upload or add a plurality of events, activities and other such information to the community organizer site 301.

It will be appreciated that a system and method for improved community activity and resource coordination have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A system for informing a group of individuals, each individual having access to an electronic computing device for accessing data over a network, the system comprising:
a server hosting a scheduling application and administrative interface configured to display a community organizer site accessible to the group of individuals;
a user interface accessed by each individual of the group of individuals for viewing the community organizer site over the network by one or more individuals of the group of individuals, and allow each individual of the group of individuals to log into a personal home page of the community organizer site and view a plurality of events communicated on the community organizer site; and
an administrative module associated with an administrative electronic computing device communicably coupled to the server, the administrative module being configured to monitor and edit the community organizer site displayed by the scheduling application and administrative interface, and wherein an administrator of the community organizer site selectably controls the administrative module to display a schedule of events viewable on the personal home page of each individual of the group of individuals.

2. The system in accordance with claim 1, wherein the personal home page of the community organizer site is selectably configured by each individual of the group of individuals to display one of a plurality of content tabs upon login to the personal home page.

3. The system in accordance with claim 1, further comprising the electronic device of each individual includes a locally managed scheduling application and administrative interface that communicates over the network to cooperate with the scheduling application and administrative interface hosted on the server.

4. The system in accordance with claim 1, wherein an individual of the group of individuals belongs to a plurality of community organizer sites and the individual of the group of individuals uses a common set of login credentials to access the personal home page for each community organizer site of the plurality of community organizer sites.

5. The system in accordance with claim 4, further comprising a my communities menu that is selectably accessed by the individual of the group of individuals, wherein the my communities menu generates a list including each community organizer site of the plurality of organizer sites the individual of the group of individual belongs to.

6. The system in accordance with claim 5, wherein the individual of the group of individuals selectably activates one community organizer site from the plurality of organizer sites to visit the personal home page associated with the selectably activated community organizer site.

7. The system in accordance with claim 1, wherein the administrative module is further configured to provide an event recommendation notification allowing the administrator to selectably recommend one or more events of the plurality of events communicated on the community organizer site.

8. The system in accordance with claim 7, wherein the event recommendation notification is configured such that only a specified group of individuals from the group of individuals receives the event recommendation notification.

9. A method of accessing a system for informing a group of individuals, each individual of the group of individuals capable of sending and receiving data related to a plurality of events over a network, the method comprising:
connecting an electronic computing device to the network;
accessing a user interface of the system, the system including a server hosting a scheduling application and administrative interface;
logging in to a first community organizer site through the user interface and each individual of the group of individuals being directed to a first personal home page of the first community organizer site;
navigating the first personal home page to view a subset of the plurality of events previously identified by each individual of the group of individuals for display on the first personal home page;
accessing a second community organizer site and being directed to a second personal home page from the first personal home page; and
navigating the second personal home page to view a subset of the plurality of events previously identified by each individual of the group of individuals for display on the second personal home page.

10. The method in accordance with claim 9, wherein the first personal home page and the second personal home page are each selectably configured to display one of a plurality of content tabs upon being directed to the first personal home page and the second personal home page.

11. The method in accordance with claim 10, wherein the plurality of content tabs includes a my interests tab, a my activities tab and an all activities tab.

12. The method in accordance with claim 9, wherein accessing the first personal home page of the first community organizer site and the second personal home page of the second community organizer site uses a common set of login credentials.

13. The method in accordance with claim 12, further comprising a my communities menu selectably accessed from the first personal home page, wherein the my communities menu generates a community list including a plurality of community organizer sites that an individual from the group of individuals belongs to.

14. The method in accordance with claim 13, wherein accessing the second personal home page includes the individual from the group of individuals selecting the second community organizer site from the community list.

15. The method in accordance with claim 9, further comprising recommending one or more of the plurality of events to the group of individuals by an administrative module of the scheduling application and administrative interface.

16. The method in accordance with claim 15, wherein recommending one or more recommended plurality of events includes sending an event recommendation to only a specified group of individuals from the group of individuals.

17. A device for informing a group of individuals about an event, each individual having access to an electronic computing device that is communicably coupled to the device, the device comprising:
a storage module;
at least one processing unit coupled to the storage module;
a scheduling application and administrative interface executed by the at least one processing unit, the scheduling application and administrative interface configured to:
display a user interface for access to a community organizer site by the group of individuals;
prompt each individual of the group of individuals to log in to the user interface and direct each individual of the group of individuals to a personal home screen of the community organizer site;
generate a community list including a plurality of community organizer sites that each individual of the group of individuals belongs to; and
allow each individual of the group of individuals to use a common set of login credentials to access the plurality of community organizer sites.

18. The device in accordance with claim 17, wherein the scheduling application and administrative interface if further configured to provide an administrative module configured to monitor and edit the community organizer site, and wherein an administrator of the community organizer site selectably controls the administrative module to display a schedule of events on the community organizer site.

19. The device in accordance with claim 18, wherein the administrative module is further configured to provide an event recommendation notification, and wherein the administrator uses the event recommendation notification to selectably recommend one or more events of the plurality of events communicated on the community organizer site.

20. The device in accordance with claim 19, wherein the event recommendation notification is configured such that only a specified group of individuals form the group of individuals receives the event recommendation notification.
